(19) United States
(12) Patent Application Publication
(10) Pub. No.: US 2011/0255271 A1
(43) Pub. Date: Oct. 20, 2011

(54) Lighted Bedroom Set

(76) Inventor: Ernella Oliver, Bradenton, FL (US)

(21) Appl. No.: 13/084,232

(22) Filed: Apr. 11, 2011

Related U.S. Application Data
(60) Provisional application No. 61/323,889, filed on Apr. 14, 2010.

(51) Int. Cl. F21V 33/00

(52) U.S. Cl. 362/130

(57) ABSTRACT

A coordinated bedroom set that incorporates a lighting means to provide a decorative furniture set with improved illumination. The bedroom set comprises matching design bed headboard, footboard, and dresser backstop. The design comprises two main posts with New England style caps, two horizontal boards and a plurality of smaller vertical posts distributed between the main posts. Illuminating lanterns are mounted on the upper region of each main post. Electrical cords for the lanterns are fed through a hollow center of each post, and on/off switches are provided thereon. The device provides improved lighting in the bedroom, without the drawbacks of overhead lighting or ceiling fan lights.

### CROSS REFERENCE TO RELATED APPLICATION

This application claims the benefit of U.S. Provisional Application No. 61/323,889 filed on Apr. 14, 2010, entitled “Mary Step Design”

### BACKGROUND OF THE INVENTION

1. Field of the Invention

The present invention relates to matching bedroom sets that incorporate lighting means, including a bed head board and dresser backstop design that provides a novel lighting feature and aesthetic features.

2. Description of the Prior Art

Décor and practicality are important factors for most consumers, especially when furnishing a home. The visual appeal of the furniture, its utility and function are all important factors that sway a customer to purchase one set of furniture over another. Combining useful features, such as ample lighting, a sleek look and a fresh design are very appealing.

The present invention is a combination bedroom furniture set and lighting source. Abundant lighting in the bedroom is important to consumers of all ages, preventing eye strain while reading, watching television, or while getting dressed. Overhead lighting can cause shadows and an unfavorable glow within a room. Lamps take up valuable space on nightstands and dressers, and are not always easily accessible from a seated or lying position while in bed. A more effective solution is required.

Lighting around a bed and throughout the room has been available since the advent of electric lighting. The devices most common in the art can be categorized into two types: one that utilizes a stand-alone lamp, attachable to a bedpost or other structure, the other a combination lamp and headboard. Several lighted headboards have been proposed in the prior art; however these devices fail to combine aesthetic features and a modern design that is practical, safe to use and easy to manufacture. Most devices employ a light source embedded in the headboard structure, but fail to propose a matching bedroom set that employs the same technology. Most utilize incandescent lighting to illuminate an area around a bed, but fail to light the rest of the room effectively or fail to describe a matching furniture set that employs a similar features and décor.

U.S. Pat. No. 1,298,362 to Lewry is a device that imbeds an incandescent light within the structure of a bed post. While this provides lighting integral with a headboard, the configuration of an internal light within the post creates intrusive shadows that do not capitalize on available light. This limits the useful light for the occupants of the room and in bed.

U.S. Pat. No. 5,683,169 to Lucas describes the use of fluorescent light bulbs in conjunction with a bed frame. While this advances the art by utilizing a more efficient bulb, the fragility of the bulb and the risk of harm if shattered are of chief concern when located in close proximity to a user when in bed. The use of such a bulb is inappropriate in such an environment because of the fragility of the bulbs, the harsh lighting such bulbs provide, and the buzzing noise commonly associated with their use.

U.S. Pat. No. 2,744,186 to Kamin is another combined headboard lighting device that integrates incandescent lamps at the top of each bed post. While the arrangement may be useful, this prior art device fails to incorporate aesthetic qualities in its design, as electric wires are visible from the exterior of the bed posts.

Similar to the Kamin device, U.S. Pat. No. 819,068 to Ives, U.S. Pat. No. 3,476,926 to Young, U.S. Pat. No. 6,595,654 to Washburn, and finally U.S. Pat. No. 1,991,111 to Murrell describe devices that integrate lighting means on or within a headboard structure. All of the prior art devices fail to integrate the lighting means into multiple structures within a room to provide ample room lighting, or fail to describe a coordinated bed headboard and dresser backstop with illumination means.

### SUMMARY OF THE INVENTION

The present invention is a matching bedroom set that provides consumers with innovative lighting options. This furniture set comprises a matching headboard, footboard, and dresser backstop made of decorative materials. A decorative, electrical lantern is positioned on each headboard post, offering users a convenient light source for reading or watching television in bed. The lanterns are also mounted on the posts of the coordinating dresser backstop, providing additional illumination throughout the room. To complete the décor of the bedroom, the furniture set includes matching knob covers that can be placed on existing dressers and nightstands for creating a sophisticated, polished look. Home owners, renters, interior decorators and other individuals will benefit from the convenience and functionality the present invention provides. The ease of manufacture associated with the present invention also reduces cost, both to the manufacturer and the consumer.

In view of the foregoing disadvantages inherent in the known types of matching bedroom sets with integral illumination means now present in the prior art, the present invention provides a new matching bedroom set with integral illumination means wherein the same can be utilized for providing convenience for the user when decorating a room with matching furniture that is both aesthetically pleasing and capable of lighting an entire bedroom with soothing, unobstructed lighting.

It is therefore an object of the present invention to provide a matching bedroom furniture set that incorporates aesthetic features and illumination means.

Another object of the present invention is to provide an integrated light within a bed headboard, and matching dresser backstop with integrated lighting.

Yet another object of the present invention is to provide an inexpensive, easy to manufacture bedroom set that provides consumers with appealing furniture, incorporating utility and décor.

Other objects, features and advantages of the present invention will become apparent from the following detailed description taken in conjunction with the accompanying drawings.

### BRIEF DESCRIPTIONS OF THE DRAWINGS

FIG. 1 shows a perspective view of the bed headboard and footboard, accompanied by a typical bed.

FIG. 2 shows a perspective view of the dresser backstop.

### DETAILED DESCRIPTION OF THE INVENTION

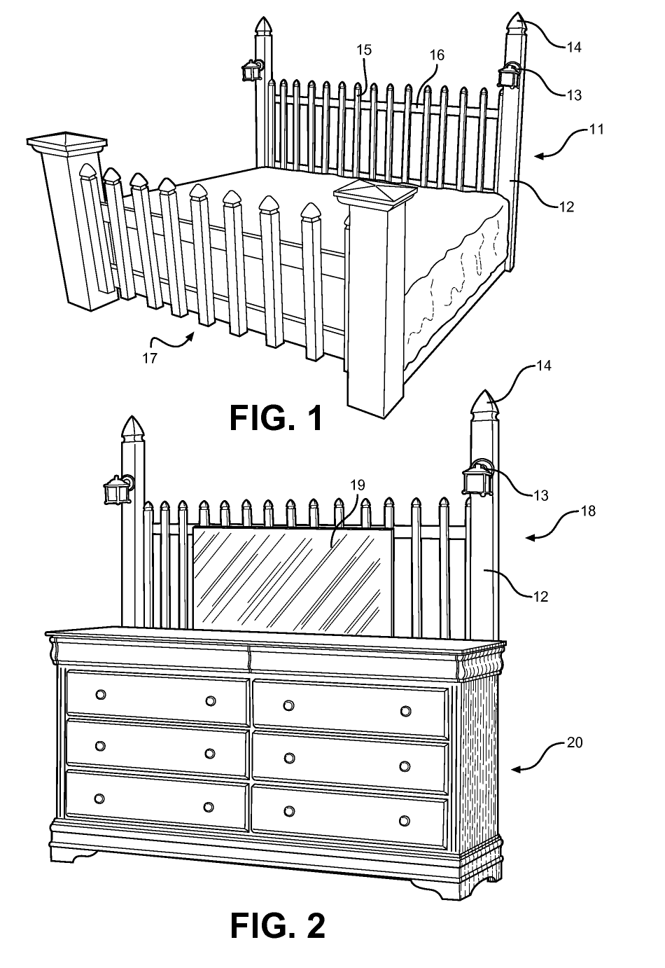

Referring now to FIG. 1, there is shown a perspective view of the bed headboard 11 and footboard 17, accompanied by a typical bed. The design of the headboard 11 and footboard 17 comprises two vertical main posts 12 on either side of a plurality of smaller vertical posts 15. Two horizontal posts 16 attach and align the vertical posts 15, which are evenly distributed between the main posts 12. The horizontal posts 16 attach to the main posts 12 to complete the design. Each of the main posts 12 and smaller vertical posts 15 have New England style caps 14. A plurality of lantern style lamps 13 are provided on the main posts 12 to provide a user with a source of light while in bed or while in the bedroom.

Electrical connections feed through the interior of the main posts 12 and down to the floor, where they exit the posts and terminate at a two NC plugs for attaching to a wall socket. Each lamp 13 has its own electrical connection, and therefore can be operated independently. An on/off switch is provided along the main post 12 exterior, in reach of a lying or seated individual in the bed.

The footboard 17 is manufactured using the same style as the headboard, with two main posts, smaller vertical posts and two horizontal posts. The headboard and footboard are connected by a bed frame below a mattress. The attachment means between the frame and boards may be a hook and latch type connection, a screw type connection or nut and bolt type connection.

Referring now to FIG. 2, there is shown a perspective view of the dresser backstop 18 design with a typical dresser 20. Similar to the style of the bed headboard and footboard, the dresser backstop 18 comprises two main posts 12, smaller vertical posts distributed between the main posts, and two horizontal posts to align and attach the assembly 18. A plurality of lantern style lamps 13 are provided on the main posts 12 for illumination purposes. The main posts 12 and smaller vertical posts are capped with New England style caps 14. A center-mounted mirror 19 is provided to help the user dress or put on make-up. The backstop 18 may be attached using the same means as that used to attach the bed headboard and footboard to the bed frame. This includes a bolted, screwed or otherwise latched connection used on the back side of the dresser 20 to attach the dresser backstop 18.

Electrical connections for the lantern bulbs are routed through a cavity within the main posts 12, down to their base. In this configuration, the electrical connection may combine into a singular wall plug, or the lanterns 13 may operate independently and require their own wall plug. User preference and manufacturing concerns will dictate whether both lanterns 13 may operate as one or independently of each other.

In use, the assembly is an easy to manufacture bedroom set that utilizes an imbedded illumination means to provide ample lighting throughout a bedroom without any unwanted glow or glare from overhead lighting or a ceiling fan lamp. The design provides a matching bedroom set that is aesthetically pleasing, while providing utility for the user in the form of imbedded lights. The lights eliminate the need to install expensive overhead lighting or place cumbersome floor or table lamps in the room beside the bed and dresser.

When decorating a bedroom, it can be difficult for a consumer to find furniture that has every attribute they are seeking. Affordability is of chief concern for most people when purchasing furniture. The look and style of the pieces are also an important aspect, as consumers want to purchase a bedroom set that is attractive and decorative, yet practical. Abundant lighting within a bedroom is important to consumers of all ages for preventing eye strain while reading, watching television, or getting dressed. The present invention combines these attributes to provide a bedroom set that is inexpensive for the consumer and provides ample illumination in the bedroom. The design is simple, yet pleasing to the eye and useful for any bedroom setup.

The materials chosen for the design may vary upon manufacturing concerns and overall cost goals for the builder and consumer. The posts may be constructed of painted or finished wood with a bored out center section for the electrical connections. Alternatively, the posts may be plastic or imitation wood for a cheaper variant of the same design. Electrical wires and connections are properly grounded and shielded to eliminate any risk of fire. The proximity to a user in bed makes this requirement a primary concern for consumers.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The bracketry associated with the connection means between the headboard, footboard and frame is of metal construction, as is the connection means between the dresser and backstop. The size of the headboard, footboard and backstop may vary depending on the size of the bed frame and dresser. Larger designs may require longer horizontal posts and more vertical posts distributed between the main posts, as necessary.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A matching bedroom set with imbedded lighting, comprising:
a bed headboard with a first and second main vertical post, a plurality of smaller vertical posts distributed evenly between said main posts, and a plurality of horizontal posts that align said smaller posts and attach to said main posts;
a bed footboard with a first and second main vertical post, a plurality of smaller vertical posts distributed evenly between said main posts, and a plurality of horizontal posts that align said smaller posts and attach to said main posts;
a dresser backstop with a first and second main vertical post, a plurality of smaller vertical posts distributed evenly between said main posts, and a plurality of horizontal posts that align said smaller posts and attach to said main posts;
a plurality of lantern style lights fixedly attached to said headboard, footboard and dresser main posts;
electrical connections for said lights traverse through a cavity in said main posts from said lights to said main post base, terminating at a wall outlet plug
said dresser backstop having a mirror fixed attached to said smaller posts and centered between said dresser backstop main posts
a bed frame attaches to and separates said bed headboard and said footboard;
said dresser backstop attached at its base to a back side of a dresser;
an electrical switch is mounted on said headboard, footboard and dresser backstop main posts to operate said lights.

2) A device as described in claim 1, wherein said posts upper termination is a New England style cap.

3) A device as described in claim 1, wherein said lamp electrical connections of said headboard and dresser backstop each terminate with a singular wall plug.

4) A device as described in claim 1, wherein said lamp electrical connections of said headboard and dresser backstop each terminate at two independent wall plugs to operate said lamps independently.

5) A device as described in claim 1, wherein said posts are made of wood.

6) A device as described in claim 1, wherein said posts are made of plastic.

7) A device as described in claim 1, wherein said posts are made of synthetic wood.
